(19) United States
(12) Patent Application Publication
(10) Pub. No.: US 2020/0096166 A1
(43) Pub. Date: Mar. 26, 2020

(54) EMERGENCY LIGHTING SYSTEM

(71) Applicants: Thomas Gamblin, Festus, MO (US); Robert Kaufmann, Waterloo, IL (US)

(72) Inventors: Thomas Gamblin, Festus, MO (US); Robert Kaufmann, Waterloo, IL (US)

(21) Appl. No.: 16/578,794

(22) Filed: Sep. 23, 2019

Related U.S. Application Data
(60) Provisional application No. 62/734,354, filed on Sep. 21, 2018.

(51) Int. Cl. F21S 9/02; H02J 7/00; H01R 24/60; H01R 24/30; H01R 27/02; F21V 33/00

(52) U.S. Cl. CPC F21S 9/022; H02J 7/0052; F21V 33/0052; H01R 24/30; H01R 27/02; H01R 24/60

(57) ABSTRACT

An emergency lighting system. The emergency lighting system includes a housing. The housing is formed by a plurality of walls. The housing also forms an interior volume, in which the internal components are placed. A power storage unit is placed in the interior volume. The power storage unit supplies power to a number of electrical slots. The electrical slots can then provide power to an object that is brought into operable connection with them. A light is also powered by the power storage unit.

### CROSS REFERENCE TO RELATED APPLICATIONS

This application claims the benefit of U.S. Provisional Application No. 62/734354 filed on Sep. 21, 2018. The above identified patent application is herein incorporated by reference in its entirety to provide continuity of disclosure.

### BACKGROUND OF THE INVENTION

The present invention relates to an emergency lighting system. More specifically, the present invention provides an apparatus that can be placed into a power system, such that when that power system fails, the emergency power system can provide light and the ability to charge a mobile device.

Electricity is, unquestionably, a vital aspect of our daily lives. For example, we use computers, mobile devices, electric lighting and numerous other apparatuses and devices for both work and recreation. In some situations, such as inclement weather or physical damage, public power systems may fail, resulting in a power outage. The outages can be localized, to specific buildings or blocks, or can be more widespread, affecting cities or other larger areas. Some buildings may be equipped with auxiliary power supplies, such as emergency generators. However, these solutions are typically not cost-effective for most single family dwellings or residential apartments.

When power outages occur, the individuals located within that dwelling may be unable to see, especially when the power outage occurs at night or during a thunderstorm. Without being able to see, the individual will be disadvantaged when moving. As such, the individual may trip or fall, which can result in an injury. Furthermore, if an individual is unable to use a mobile phone, because it needs to be charged, they will be unable to contact friends, family members, or emergency responders if necessary. This can be dangerous in the event that the individual become injured or needs emergency assistance. Accordingly, there is a defined need for a device that can provide mobile device charging capabilities while acting as a light source during a power outage.

### SUMMARY OF THE INVENTION

In view of the foregoing disadvantages inherent in the known types of power outage emergency lighting systems and apparatuses now present in the prior art, the present invention provides an emergency lighting system wherein the same can be utilized for providing convenience for the user when providing an electricity supply during a power outage.

The present system comprises a housing. The housing is formed by a plurality of walls. The plurality of walls is adjoined together, such that they form an interior volume. A power storage unit, at least, is disposed in the interior volume. The power storage unit is in operable connection with a plurality of electrical slots. The plurality of electrical slots is disposed on an exterior surface of the housing, and are placed such that they are accessible by the individual to charge a device, such as a mobile device. The power storage unit is also in operable connection with at least one light. The light is disposed on an external surface of the housing.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective front view of an embodiment of the emergency lighting system.

FIG. 2 shows a block diagram of an embodiment of the emergency lighting system.

FIG. 3 shows a perspective rear view of an embodiment of the emergency lighting system.

FIG. 4 shows a perspective view of an embodiment of the emergency lighting system in use.

### DETAILED DESCRIPTION OF THE INVENTION

Reference is made herein to the attached drawings. Like reference numerals are used throughout the drawings to depict like or similar elements of the XXX. The figures are intended for representative purposes only and should not be considered to be limiting in any respect.

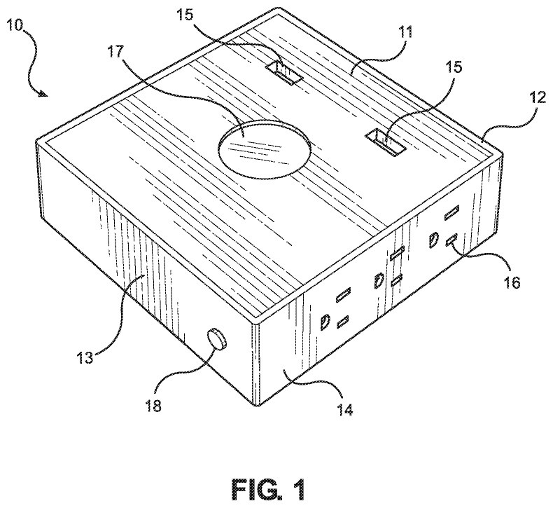

Referring now to FIG. 1, there is shown a perspective front view of an embodiment of the emergency lighting system. The emergency lighting system 10 comprises a plurality of walls. The plurality of walls is arranged together, such that a housing is formed by the plurality of walls. In the illustrated embodiment, the plurality of walls comprises a front wall 11 disposed oppositely a rear wall (shown in FIG. 3), a top wall 12 disposed oppositely a bottom wall 13 and a pair of opposing side walls 14. In the illustrated embodiment, the housing comprises a front wall 11 that is substantially in the shape of a square. In alternate embodiments, the housing may be of any suitable shape. The housing defines an interior volume with a power storage unit disposed therein.

A plurality of electrical slots 15, 16 are disposed on an external surface of the front wall 11 of the plurality of walls. In the illustrated embodiment, the plurality of electrical slots comprises at least one universal serial bus (USB) port 15. The universal serial bus port 15 is commonly utilized to charge mobile devices, such as mobile phones. As such, the individual will be enabled to charge a mobile device, such as a mobile phone, utilizing the emergency lighting system 10. Additionally, in the illustrated embodiment, the plurality of electrical slots comprises at least one electrical socket 16. As such, standard electronic devices can be powered using the emergency lighting system 10. Additionally, in some embodiments, the electrical sockets 16 may provide convenience by allowing for access to an electrical socket when a wall-mounted electrical socket is being utilized to power the emergency lighting system 10 itself.

As shown, the emergency lighting system 10 further comprises at least one light 17 disposed on an external surface of the housing. In the illustrated embodiment, the light 17 is centrally disposed on an external surface of the front wall 11 of the plurality of walls. In alternative embodiments, the light 17 is positioned to direct light to a specific location, such as below the housing or to the sides of the housing. The light 17 is in operable connection with a light actuator 18. The light actuator 18 is configured to activate and to deactivate the light 17 when engaged by the user. As such, the user may be able to manually activate and deactivate the light 17 regardless of if there is or is not a current power outage. The light 17 is of any suitable composition or configuration. In some embodiments, the light 17 is a light emitting diode (LED).

In some embodiments, the light actuator 18 comprises a three way switch. The three way switch is movable between a first position, a second position and a third position. The first position corresponds to an actuated configuration, wherein the light 17 is actuated when a power outage is detected. The second position corresponds to a deactivated configuration, wherein the light 17 is not actuated in the event of a power outage, while the plurality of electrical slots 15, 16 are still usable. The third position corresponds to an automatic activation configuration, wherein the light 17 is activated at a low level when a low amount of light is detected and activated at a high level when a power outage is detected.

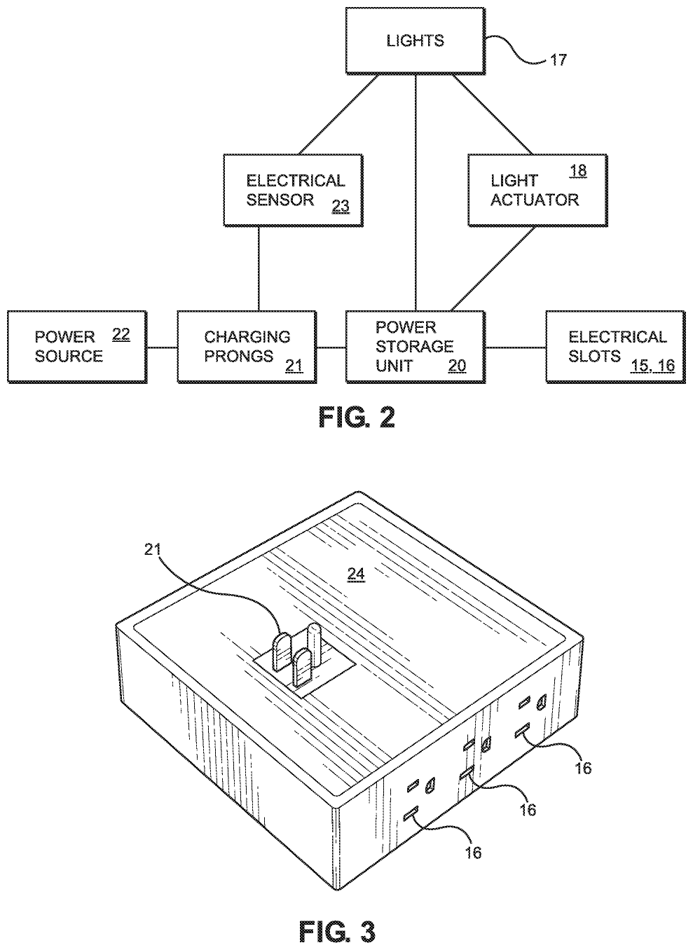

Referring now to FIG. 2, there is shown a block diagram of an embodiment of the emergency lighting system. The emergency lighting system comprises a power storage unit 20. The power storage unit 20 is configured to store electrical power that is received into it. In some embodiments (such as the embodiment illustrated in FIG. 3) the power storage unit 20 is in operable connection with charging prongs 21 that receive power from a power source 22, such as an electrical socket. In other embodiments, the power storage unit 20 may be a battery. In a further embodiment, the powerstorage unit 20 may be a rechargeable battery that is charged by a connection with the power source 22.

In some embodiments, the emergency lighting system further comprises an electrical sensor 23 disposed in the interior volume of the housing. The electrical sensor 23 is in operable connection between the light 17 and the charging prongs 21. The electrical sensor 23 is configured to actuate the light 17 when electricity is no longer being supplied to the charging prongs 21. As such, during a power outage, the light 17 will be actuated when the charging prongs 21 are no longer being supplied with electricity, thus not requiring the user to manually actuate the light 17 in the event of a power outage. However, in such embodiments, the emergency lighting system may still comprise a light actuator 18 in operable connection with the light 17, such that the user is still capable of manually actuating the light 17 while the light 17 is still automatically actuatable in the event of a power outage.

Referring now to FIG. 3, there is shown a perspective rear view of an embodiment of the emergency lighting system. In the illustrated embodiment, the emergency lighting system further comprises a plurality of charging prongs 21 disposed on a rear wall 24 of the housing. The plurality of charging prongs 21 are in operable connection with the power storage unit, such that power can flow from the power source, through the plurality of charging prongs 21, into the power storage unit. Furthermore, in some embodiments, the plurality of charging prongs 21 are in direct operable connection with the electrical sockets 16 on the external surface of the housing, such that the electrical sockets 16 can be used when the underlying electrical sockets are blocked by the housing.

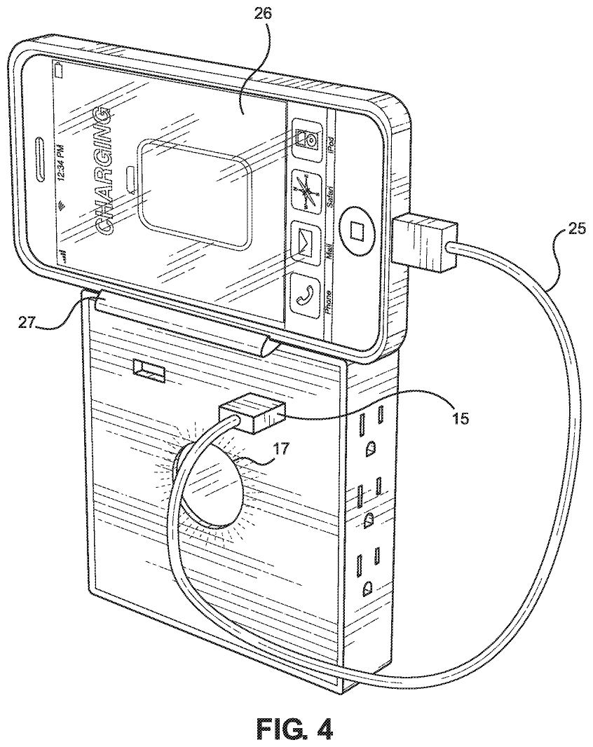

Referring now to FIG. 4, there is shown a perspective view of an embodiment of the emergency lighting system in use. In the illustrated embodiment, the emergency lighting system is disposed upon a vertical surface, such as a wall. The plurality of walls are is such that the emergency lighting system is a low profile housing that does not extend from the wall more than necessary.

In the illustrated embodiment, the light 17 is actuated, and the power is being supplied to the plurality of electrical slots 15. As such, a mobile device (illustrated as a mobile phone) 26 may be charged by engaging a charging cable 25 with the mobile 26 and an electrical slot of the plurality of electrical slots 15. In the illustrated embodiment, the top wall of the housing provides a flat surface, such that a mobile device 26 can be placed thereon. Furthermore, as shown, the top wall may comprise a lip 27. The lip 27 is configured to provide support to a mobile device that is placed upon the top wall.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1) An emergency lighting system, comprising:
a plurality of walls, wherein the plurality of walls is arranged to form a housing;
the housing defining an interior volume;
a power storage unit disposed in the interior volume;
a plurality of electrical slots disposed on an exterior surface of a front wall of the housing;
the plurality of electrical slots in operable connection with the power storage unit;
at least one light disposed on an external surface of the housing.

2) The emergency lighting system of claim 1, further comprising a plurality of charging prongs disposed on an exterior surface of a rear wall of the housing.

3) The emergency lighting system of claim 2, wherein the plurality of charging prongs is configured to engage an electrical outlet.

4) The emergency lighting system of claim 1, wherein the plurality of electrical slots comprises a universal serial bus port.

5) The emergency lighting system of claim 1, wherein the plurality of electrical slots comprises an electrical socket.

6) The emergency lighting system of claim 1, wherein the power storage unit is a battery.

7) The emergency lighting system of claim 1, wherein the battery is a rechargeable battery.

8) The emergency lighting system of claim 1, wherein an electrical sensor is disposed in the interior volume.

9) The emergency lighting system of claim 8, wherein the electrical sensor is configured to actuate the at least one light in the event of a power outage.

10) The emergency lighting system of claim 1, wherein a top wall of the housing provides a flat surface

11) The emergency lighting system of claim 1, wherein a light actuator is operably disposed between the at least one light and the power storage unit.

12) The emergency lighting system of claim 1, wherein the light is an LED.

13) The emergency lighting system of claim 1, wherein the light actuator comprises:
a three way switch that is movable between a first position, second position and a third position;
the first position corresponds to an actuated configuration, wherein the light is actuated when a power outage is detected;
the second position corresponds to a deactivated configuration, wherein the light is not actuated in the event of a power outage, while the plurality of electrical slots are still usable;
the third position corresponds to an automatic activation configuration, wherein the light is activated at a low level when a low amount of light is detected and activated at a high level when a power outage is detected.
